(19) United States
(12) Patent Application Publication
(10) Pub. No.: US 2018/0155066 A1
(43) Pub. Date: Jun. 7, 2018

(54) METHOD AND APPARATUS FOR CONTROLLING ORBIT OF COLLOCATED SATELLITE

(71) Applicant: Electronics and Telecommunications Research Institute, Daejeon (KR)

(72) Inventors: Yoola HWANG, Daejeon (KR); Byoung-Sun LEE, Daejeon (KR)

(73) Assignee: Electronics and Telecommunications Research Institute, Daejeon (KR)

(21) Appl. No.: 15/495,437

(22) Filed: Apr. 24, 2017

(30) Foreign Application Priority Data
Dec. 1, 2016 (KR) 1020160162844
Apr. 10, 2017 (KR) 1020170045988

(51) Int. Cl. B64G 1/24

(52) U.S. Cl. CPC B64G 1/242

(57) ABSTRACT

Provided is a satellite orbit controlling method and apparatus. A satellite orbit adjusting method performed at a current satellite may include measuring a distance between the current satellite and another satellite using a radio frequency; calculating a relative location relationship between the current satellite and the other satellite based on the measured distance, and estimating an orbit element based on the location relationship; calculating speed increment information for controlling a maneuver based on the estimated orbit element; and adjusting a satellite orbit of the current satellite based on the speed increment information.

### CROSS-REFERENCE TO RELATED APPLICATION(S)

This application claims the priority benefit of Korean Patent Application No. 10-2016-0162844 filed on Dec. 1, 2016, and Korean Patent Application No. 10-2017-0045988 filed on Apr. 10, 2017, in the Korean Intellectual Property Office, the disclosures of which are incorporated herein by reference for all purposes.

### BACKGROUND

### 1. Field

At least one example embodiment relates to a satellite orbit adjusting method and apparatus.

### 2. Description of Related Art

A geostationary satellite drifts to a stable point. Thus, to implement a given mission, the geostationary satellite needs to perform a maneuver within a predetermined period and to be maintained in a predetermined control box. In particular, many geostationary satellites are operating at limited altitudes and latitudes. Further, the increased necessity for commercial communication satellites may lead to operating a more number of satellites than the current time.

In the recent times, many satellites may operate using an onboard memory or may operate through automation. A collocated satellite operation of a geostationary satellite needs to be aware of a maneuver schedule or an operation schedule of another satellite. However, the collocated satellite operation is difficult without mutual collaboration.

### SUMMARY

According to an aspect of at least one example embodiment, there is provided a satellite orbit adjusting method performed at a current satellite for collocated satellite operation, the method including measuring a distance between the current satellite and another satellite using a radio frequency on an onboard memory; calculating a relative location relationship between the current satellite and the other satellite based on the measured distance, and estimating an orbit element based on the location relationship; calculating speed increment information for controlling a maneuver based on the estimated orbit element; and adjusting a satellite orbit of the current satellite based on the speed increment information.

The estimating may include calculating a relative location of the other satellite from the current satellite based on data of the measured distance.

The calculating may include calculating a value of a relative eccentricity vector and a value of a relative gradient vector based on the estimated orbit element.

The calculating may include calculating the speed increment information so that the relative eccentricity vector and the relative gradient vector are in a parallel state.

The calculating may include calculating the speed increment information so that the relative eccentricity vector and the relative gradient vector are in a parallel state.

The measuring may include modulating or demodulating a signal of the radio frequency.

The calculating may include calculating a speed increment to maintain a satellite moving at a draft rate of the satellite within a box for maintaining a location corresponding to an east-west direction.

The calculating may include determining a maneuver time based on a change in an eccentricity by solar perturbation using a speed increment determined based on a satellite change rate.

The calculating may include determining a maneuver time by including or adding a bias value in or to an eccentricity vector for a collocated satellite operation.

The calculating may include determining a speed increment and a maneuver time to maintain an orbit gradient change by sun and moon within a box for maintaining a location corresponding to a south-north direction using an orbit gradient vector.

The calculating may include determining a speed increment and a maneuver time by including or adding a bias value in or to an eccentricity vector for a collocated satellite operation.

According to an aspect of at least one example embodiment, there is provided a satellite orbit adjusting apparatus including a relative location calculator configured to measure a distance between a current satellite and another satellite using a radio frequency, and to calculate a relative location relationship between the current satellite and the other satellite based on the measured distance; and a speed increment calculator configured to estimate an orbit element based on the location relationship, and to calculate speed increment information for controlling a maneuver based on the estimated orbit element. A satellite orbit of the current satellite is adjusted based on the speed increment information.

The speed increment calculator may be configured to calculate a value of a relative eccentricity vector and a value of a relative gradient vector based on the estimated orbit element.

The speed increment calculator may be configured to determine a maneuver time based on a change in an eccentricity.

According to an aspect of at least one example embodiment, there is provided a satellite orbit adjusting apparatus including a relative location calculator configured to measure a distance between a current satellite and another satellite using a radio frequency;

and a speed increment calculator configured to estimate an orbit element of the current satellite based on the measured distance, to control a maneuver of the current satellite based on the estimated orbit element, and to adjust the satellite orbit of the current satellite.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a flowchart illustrating an example of a satellite orbit adjusting method according to an example embodiment;

FIG. 2 is a block diagram illustrating an example of a satellite orbit adjusting apparatus according to an example embodiment;

FIG. 3 is a block diagram illustrating another example of a satellite orbit adjusting apparatus according to an example embodiment;

FIG. 4 is a flowchart illustrating another example of a satellite orbit adjusting method according to an example embodiment; and

FIG. 5 illustrates examples of describing relative eccentric vectors and relative orbit gradient vectors of satellites according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described in the specification that one component is “connected”, “coupled”, or “joined” to another component, a third component may be “connected”, “coupled”, and “joined” between the first and second components, although the first component may be directly connected, coupled or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Meanwhile, depending on example embodiments, a function or an operation specified in a specific block may be performed in a manner different from the illustration. For example, consecutive two blocks may be performed substantially at the same time, and order of the corresponding blocks may be changed and thereby performed based on a known function or operation.

Hereinafter, example embodiments are described with reference to the accompanying drawings. Here, like reference numerals refer to like elements throughout the present specification and a repeated description is omitted.

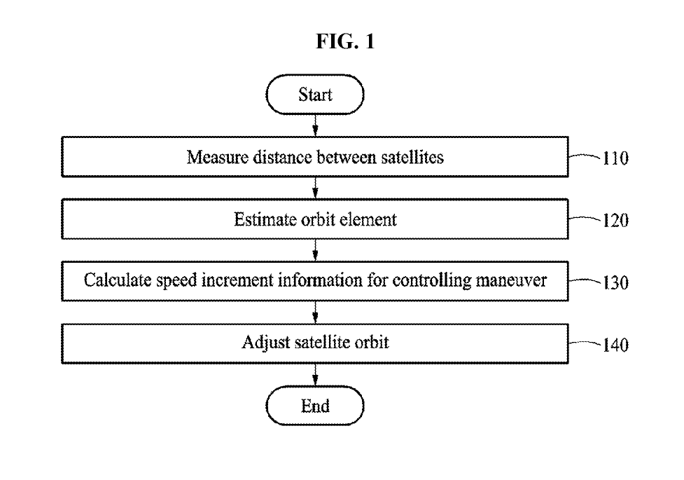

FIG. 1 is a flowchart illustrating an example of a satellite orbit adjusting method according to an example embodiment.

A satellite orbit adjusting apparatus according to an example embodiment may mount, to a satellite onboard memory, a radio transceiving device, such as a frequency modulation continuous wave (FMCW) radar capable of performing communication, for example, wireless communication. The satellite orbit adjusting apparatus may measure a distance between satellites by transmitting and receiving signals between the satellites through an omni antenna and may calculate a location of the satellite orbit adjusting apparatus and a location of a counter party satellite using an onboard memory. The satellite orbit adjusting apparatus may collocate and thereby operate satellites by adjusting a maneuver value for maintaining a location for collocation operation of the satellites using a calculated relative location relationship and the like, and by performing a maneuver.

A satellite that includes the satellite orbit adjusting apparatus and is a collocation operation target may communicate with another satellite using a radio frequency (RF) communication device capable of performing transmission and reception. Also, the satellite orbit adjusting apparatus may perform a location maintaining maneuver for collocated satellite operation using an onboard memory of the satellite into consideration of a limit condition by recognizing or calculating a relative location using the onboard memory of the satellite and by calculating a mutual relative orbit element.

The satellite orbit adjusting apparatus may reduce a risk by collision between geostationary satellites on the ground. The satellite orbit adjusting apparatus may cope with a collision risk by calculating a relative location between satellites regardless of a presence of an error by orbit determination on a single ground station and by performing a maneuver. The maneuver relates to an artificial modification and manipulation for a posture or an orbit of an aerospace craft, such as a rocket, an artificial satellite, and the like. A light propulsion system with accurately controllable driving power may be mounted to the aerospace craft. The maneuver may indicate an orbit correction, such an orbit entry, rendezvous, correction of a deviated orbit, and the like.

Referring to FIG. 1, the satellite orbit adjusting method performed by the satellite orbit adjusting apparatus may include the following operations. The satellite orbit adjusting apparatus may be the satellite itself or may be included in at least a part of the satellite.

In operation 110, the satellite orbit adjusting apparatus may measure a distance between the current satellite and another satellite using a radio frequency. The satellite orbit adjusting apparatus may receive a signal in which a radio frequency transmitted from the current satellite is reflected by the other satellite. For example, the satellite orbit adjusting apparatus may receive a signal in which a radio frequency transmitted from a first satellite is reflected by a second satellite different from the first satellite.

The satellite orbit adjusting apparatus may receive signals in which the radio frequency transmitted from the current satellite is reflected by different satellites, respectively. For example, the satellite orbit adjusting apparatus may receive a signal in which a radio frequency transmitted from the first satellite is reflected by the second satellite different from the first satellite and may receive a signal in which the radio frequency transmitted from the first satellite is reflected by a third satellite different from the first satellite and the second satellite. Depending on cases, radio frequencies transmitted from the first satellite may be radio frequencies in different bands. The satellite orbit adjusting apparatus may modulate or demodulate a signal of a radio frequency.

In operation 120, the satellite orbit adjusting apparatus may calculate a relative location relationship between the current location and the other satellite based on the measured distance, and may estimate an orbit element based on the location relationship. The satellite orbit adjusting apparatus may calculate a relative location of the other satellite from the current satellite based on data of the measured distance. The satellite orbit adjusting apparatus may calculate a relative orbit element based on the calculated relative location and may apply the calculated relative orbit element to calculate a speed increment.

In operation 130, the satellite orbit adjusting apparatus may calculate speed increment information for controlling a maneuver based on the estimated orbit element. The satellite orbit adjusting apparatus may calculate vector information based on the estimated orbit element. For example, the satellite orbit adjusting apparatus may calculate a value of a relative eccentricity vector and a value of a relative gradient vector based on the estimated orbit element.

The satellite orbit adjusting apparatus may calculate speed increment information by adjusting an eccentricity vector bias and a gradient vector bias so that the relative eccentricity vector and the relative gradient vector may constitute a parallel state. The satellite orbit adjusting apparatus may calculate speed increment information so that the relative eccentricity vector and the relative gradient vector may not be vertical to each other. The satellite orbit adjusting apparatus may determine a maneuver time based on a change in an eccentricity.

In operation 140, the satellite orbit adjusting apparatus may adjust a satellite orbit of the current satellite based on the speed increment information. Depending on cases, the satellite orbit adjusting apparatus may also transmit, to the other satellite, control information for controlling the satellite orbit of the current satellite and a satellite orbit of the other satellite based on the speed increment information.

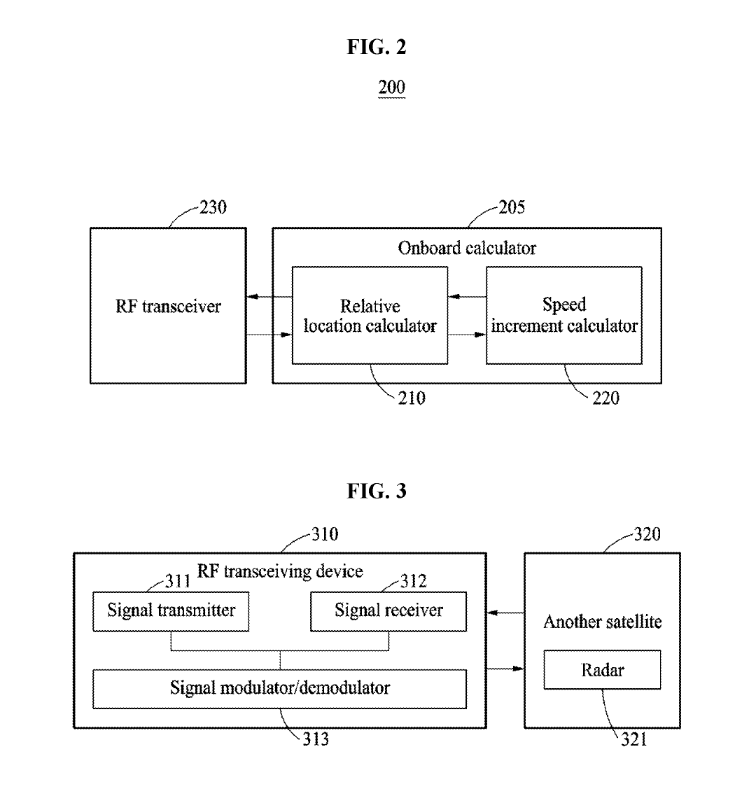

FIG. 2 is a block diagram illustrating an example of a satellite orbit adjusting apparatus according to an example embodiment.

FIG. 2 illustrates a configuration of a satellite orbit adjusting apparatus 200 for a collocated satellite operation of a geostationary satellite. Referring to FIG. 2, the satellite orbit adjusting apparatus 200 may include an RF transceiver 230 and an onboard calculator 205. The onboard calculator 205 may include a relative location calculator 210 and a speed increment calculator 220. The RF transceiver 230 may refer to a communication device that is provided to the satellite and is configured to transmit and receive a radio frequency.

The relative location calculator 210 may calculate a relative orbit element by measuring a relative distance from an approaching satellite. That is, the relative location calculator 210 may calculate a relative location between a current satellite and another satellite based on a distance between the current satellite and the other satellite. The relative location calculator 210 is aware of a location of a reference satellite and thus, may calculate a location of a relative satellite that is a location of the other satellite by applying a least square fit using a radio frequency transmitted from the other satellite.

The relative location calculator 210 may transmit a signal to the other satellite using an RF transceiving device, such as an FMCW radar, from a geographical satellite. The relative location calculator 210 may receive a signal reflected from another satellite signal and may calculate a distance between two satellites. Here, the relative location calculator 210 may calculate a distance from a satellite within about 100 km by increasing the power of the FMCW radar. Also, the relative location calculator 210 may measure a distance from each of a plurality of satellites. Also, the relative location calculator 210 may calculate a relative location between two satellites based on data of the measured distance, and may calculate a relative orbit element.

The speed increment calculator 220 may calculate a speed increment value and the like to perform a maneuver by applying the calculated relative orbit element. That is, the speed increment calculator 220 may calculate a speed increment and may calculate vector information by a relative location by adding a bias vector to eccentricity and gradient vector values with respect to an east-west direction and a south-north direction using the orbit element of the other satellite that is calculated based on the calculated relative location. Also, the speed increment calculator 220 may calculate the speed increment so that the calculated vector information may satisfy a condition about a distance between the satellite and the other satellite.

The speed increment calculator 220 may calculate a value of a relative eccentricity vector and a value of a relative gradient vector based on the calculated relative orbit element. The speed increment calculator 220 may calculate or set the speed increment so that the relative eccentricity vector and the relative gradient vector may be in a parallel state or so that a location of the satellite geometrically optimized for a collocated satellite operation may be maintained. The speed increment calculator 220 may calculate or set the speed increment so that the geometrically optimized location of the satellite may be maintained or so that the relative eccentricity vector and the relative gradient vector may not be vertical.

The speed increment calculator 220 may recalculate the speed increment by applying a thruster model to the calculated speed increment, and may calculate or set the speed increment for the collocated satellite operation by adjusting a satellite location to be maintained based on the maneuver time. The speed increment calculator 220 may perform a single burn using a speed increment by drift of the satellite from an absolute location of the satellite. Also, the speed increment calculator 220 may maintain an eccentricity vector by performing two-burn when a magnitude of the eccentricity vector exceeds a threshold due to a relative great perturbation by eccentricity and may operate or set an east-west direction with respect to a single satellite.

Also, in the case of adjusting a location for the south-north direction to be maintained, the speed increment calculator 220 may maintain a latitude of the satellite to be within zero degree to 0.05 degrees by transmitting an orbit gradient vector of the absolute location to an origin. Here, to maintain locations of satellites within the same longitude, such as collocated satellites, a satellite location may be adjusted to be maintained by providing a basis to an eccentricity vector at the absolute location and an orbit gradient vector at the absolute location for each satellite. Here, to maintain the relative eccentricity vector and the relative orbit gradient vector not to be vertical may be a strategy for the collocated satellite operation.

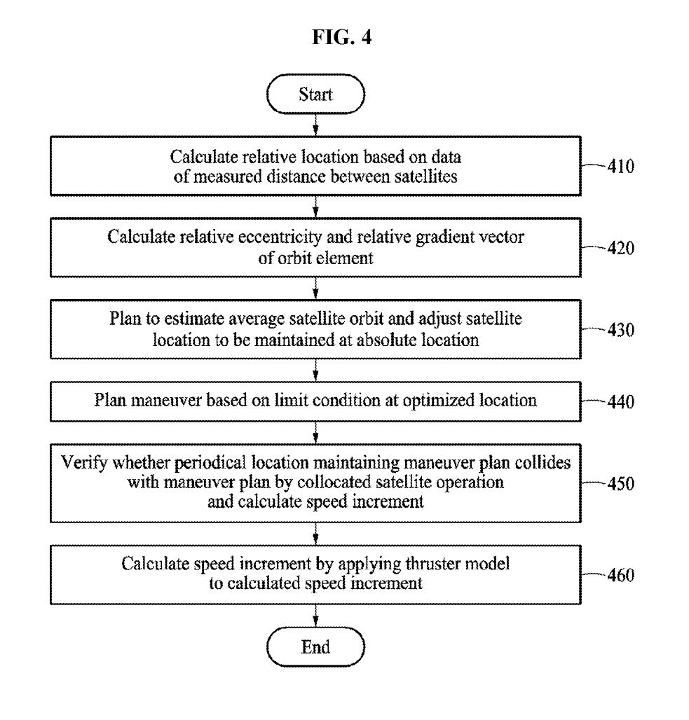

FIG. 3 is a block diagram illustrating another example of a satellite orbit adjusting apparatus according to an example embodiment.

FIG. 3 illustrates a configuration of a radar that is an RF transceiving device 310 of a satellite orbit adjusting apparatus. Depending on cases, the satellite orbit adjusting apparatus may be mounted to another satellite 320. A radar 321 of the other satellite 320 may be an RF transceiving device different from the RF transceiving device 310.

A signal transmitter 311 included in the RF transceiving device 310 may transmit a signal to another satellite located at the same longitude. Also, a signal receiver 312 may receive a signal. Also, a signal modulator/demodulator 313 may modulate or demodulate the transmitted or received signal. Here, the satellite orbit adjusting apparatus may calculate a relative distance between satellites using the modulated or demodulated signal.

The satellite orbit adjusting apparatus may estimate an orbit for a normal operation of a geostationary satellite using the relative distance. For example, the satellite orbit adjusting apparatus may also estimate a relative satellite location. Also, the satellite orbit adjusting apparatus may apply an existing sensitivity model used for orbit determination and orbit estimation and a perturbation model used for calculating a Jacobian matrix to a method of calculating a relative location.

FIG. 4 is a flowchart illustrating another example of a satellite orbit adjusting method according to an example embodiment.

Referring to FIG. 4, the satellite orbit adjusting method performed by the satellite orbit adjusting apparatus may include the following operations. The satellite orbit adjusting apparatus may calculate a relative location between satellites, and may calculate a relative eccentricity vector and a relative gradient vector. Also, the satellite orbit adjusting apparatus may adjust a satellite location to be maintained by estimating an orbit using an eccentricity vector and a gradient vector having a bias as an absolute location of the satellite and by applying a calculated relative location.

In operation 410, the satellite orbit adjusting apparatus may calculate a relative location based on data of a measured distance between satellites. In operation 420, the satellite orbit adjusting apparatus may calculate a relative eccentricity and a relative gradient vector of an orbit element.

In operation 430, the satellite orbit adjusting apparatus may plan to estimate an average satellite orbit and to adjust a satellite location to be maintained at an absolute location. In operation 440, the satellite orbit adjusting apparatus may plan a maneuver based on a limit condition at an optimized location.

In operation 450, the satellite orbit adjusting apparatus may verify whether a periodical location maintaining maneuver plan collides with a maneuver plan by collocated satellite operation and may calculate a speed increment. In operation 460, the satellite orbit adjusting apparatus may calculate the speed increment by applying a thruster model to the calculated speed increment.

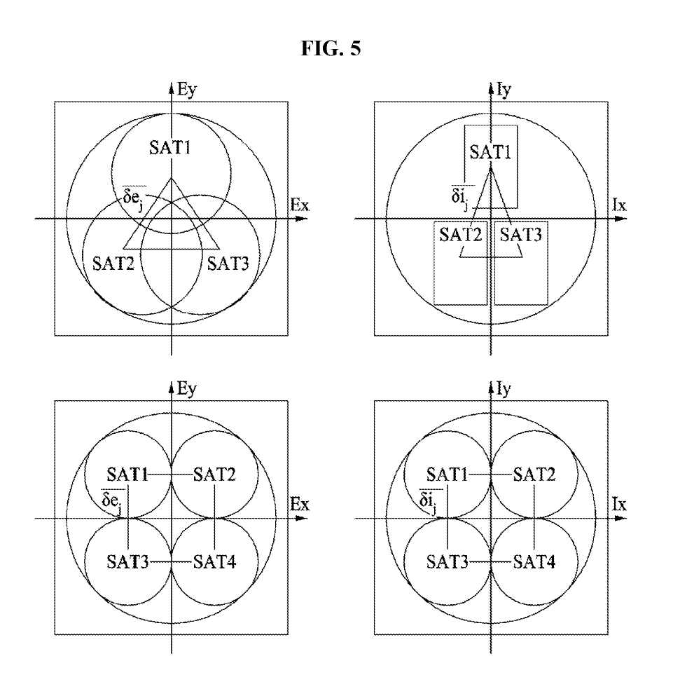

FIG. 5 illustrates examples of describing relative eccentric vectors and relative orbit gradient vectors of satellites according to an example embodiment.

The satellite orbit adjusting apparatus may set an inner product between eccentricity vectors and gradient vector of relative satellites not to be vertical. Also, the satellite orbit adjusting apparatus may set an inner product between relative eccentricity and gradient vectors to be maintained in a parallel state.

The satellite orbit adjusting apparatus may calculate a relative electricity vector and a relative gradient vector of each satellite using a location vector of a relative satellite.

According to an example embodiment, the satellite orbit adjusting apparatus may calculate or set the relative eccentricity vector and the relative gradient vector to satisfy the following Equation 1 for a collocated satellite operation. The satellite orbit adjusting apparatus may calculate or set the relative eccentricity vector or the relative gradient vector so that an eccentricity of an east-west direction may be maintained within an eccentricity control radius

\vec{δeⱼ}=(δe_{c}, δeₛ), \vec{δiⱼ}=(δi_{c}, δiₛ)

\vec{δeⱼ}·\vec{δiⱼ}≈0 or \vec{δeⱼ}·\vec{δiⱼ}=|\vec{δeⱼ}||\vec{δiⱼ}|, |\vec{δeⱼ}|<γ, |\vec{iⱼ}|<α (1)

In Equation 1, γ denotes a control limit magnitude of an eccentricity vector that is an eccentricity control radius for each satellite, and α denotes a gradient control limit magnitude of each satellite. \vec{δcⱼ} denotes a difference value between eccentricity vectors of satellites, and \vec{δiⱼ} denotes a difference value between orbit gradient vectors of satellites. Further, \vec{δeⱼ}·\vec{δiⱼ} denotes an inner product associated with a relative value of an eccentricity vector and an orbit gradient vector of each satellite, |\vec{δeⱼ}|\vec{δiⱼ}| denotes a multiplication of magnitudes of relative eccentricity and orbit gradient vectors, \vec{δeⱼ}| denotes a magnitude of a relative eccentricity vector, |\vec{δiⱼ}| denotes a magnitude of a relative orbit gradient vector, |\vec{eⱼ}| denotes a magnitude of an eccentricity vector of each satellite, and |\vec{iⱼ}| denotes a magnitude of an orbit gradient vector of each satellite.

\vec{δeⱼ} denotes a difference value between eccentricity vectors (δe_{c}, δeₛ) of satellites, and δe_{c} and δeₛ may be defined as shown in Equation 2 and Equation 3, respectively.

δe_{c}=eₖ(cos(ωₖ+Ωₖ))−eⱼ(cos(ωⱼ+Ωⱼ)) (2)

In Equation 2, δe_{c} denotes an x-axial component vector of an eccentricity of each satellite, eₖ, eⱼ denotes an eccentricity for each satellite, ω denotes an argument of perigee of a satellite, and Ω denotes a right ascension ascending node of a satellite. Here, subscripts k and j denote identifiers of the respective satellites.

δeₛ=eₖ(sin(ωₖ+Ωₖ))−eⱼ(sin(ωⱼ+Ωⱼ)) (3)

In Equation 3, δeₛ denotes an y-axial component vector of an eccentricity of each satellite. The remaining variables eₖ, eⱼ, ω, and Ω, and subscripts k and j may be defined as in Equation 2.

In Equation 1, each of \vec{δi}ⱼ, \vec{δi}ₖ denotes a difference value between orbit gradient vectors (δi_{c}, δiₛ) of satellites, and δi_{c} and δiₛ may be defined as Equation 4 and Equation 5, respectively.

δi_{c}=iₖ(cos(Ωₖ))−iⱼ(cos(Ωⱼ)) (4)

δiₛ=iₖ(sin(Ωₖ))−iⱼ(sin(Ωⱼ)) (5)

In Equation 4 and Equation 5, each of iₖ, iⱼ denotes an orbit gradient of each satellite, ω, Ω, and subscripts k and j may be defined as in Equation 2.

The satellite orbit adjusting apparatus may calculate a drift of a satellite for a periodical location maintaining maneuver and may calculate a speed increment for maintaining a satellite in an east-west direction. Also, the satellite orbit adjusting apparatus may determine a maneuver time based on a change in an eccentricity by solar wind perturbation, and if two-burn is required, may perform two-burn with respect to the speed increment by the change in the electricity.

The satellite orbit adjusting apparatus may control a satellite to be maintained within a control box in a south-north direction by applying an algorithm, for example, a minimum fuel target (MFT), with respect to the south-north direction and by using a gradient vector. Here, the satellite orbit adjusting apparatus may periodically perform a location maintaining maneuver by applying a bias to eccentricities and gradient vectors of satellites with respect to the east-west direction and the south-north direction at the same longitude for a collocated satellite operation.

The satellite orbit adjusting apparatus may determine or calculate a maneuver time by including or adding a bias value in or to a relative eccentricity vector. Also, the satellite orbit adjusting apparatus may determine or calculate speed increment information or the maneuver time by including or adding the bias value in or to the relative gradient vector.

The satellite orbit adjusting apparatus may geometrically separate a longitude with respect to two satellites. Also, the satellite orbit adjusting apparatus may maintain satellites within a control box within the same longitude using geometry, for example, applying an isosceles triangle to three satellites, for example, SAT1, SAT2, and SAT3, and applying a square to four satellites, for example, SAT1, SAT2, SAT3, and SAT4.

Here, the satellite orbit adjusting apparatus may plan a location maintaining maneuver for a normal operation by applying a bias to an eccentricity vector and a gradient vector. Meanwhile, the satellite orbit adjusting apparatus may calculate a speed increment based on a limit condition, to allow a collocation with respect to a location of a satellite that varies over time due to an effect of perturbation by different weights and sizes of different satellites during a collocation operation. The satellite orbit adjusting apparatus may perform a maneuver using an onboard memory by reconstructing the calculated speed increment using a thruseter model according to a thruster mounted to a satellite bus body.

The satellite orbit adjusting apparatus may be applied to a collocated satellite operation for operating a plurality of geostationary satellites. The satellite orbit adjusting apparatus may perform a collocated satellite operation by transmitting and receiving ratio signals using an onboard memory, without a satellite maneuver plan on the ground. Also, in the case of using a ground station, the satellite orbit adjusting apparatus may perform the collocated satellite operation based on a relative location without a need to correct a biased location of a satellite that is inaccurately known.

The components described in the example embodiments may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the example embodiments may be achieved by software, and the software may be recorded on a recording medium. The components, the functions, and the processes described in the example embodiments may be achieved by a combination of hardware and software.

The apparatuses described herein may be implemented using hardware components, software components, and/or combination of the hardware components and the software components. For example, the apparatuses and the components may be configured using at least one universal computer or special purpose computer, for example, a processor, a controller and an arithmetic logic unit (ALU), a digital signal processor, a microcomputer, a field programmable array (FPA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct and/or configure the processing device to operate as desired, thereby transforming the processing device into a special purpose processor. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A satellite orbit adjusting method performed at a current satellite, the method comprising:
measuring a distance between the current satellite and another satellite using a radio frequency;
calculating a relative location relationship between the current satellite and the other satellite based on the measured distance, and estimating an orbit element based on the location relationship;
calculating speed increment information for controlling a maneuver based on the estimated orbit element; and
adjusting a satellite orbit of the current satellite based on the speed increment information.

2. The method of claim 1, wherein the estimating comprises calculating a relative location of the other satellite from the current satellite based on data of the measured distance.

3. The method of claim 1, wherein the calculating comprises calculating a value of a relative eccentricity vector and a value of a relative gradient vector based on the estimated orbit element.

4. The method of claim 3, wherein the calculating comprises calculating the speed increment information so that the relative eccentricity vector and the relative gradient vector are in a parallel state.

5. The method of claim 3, wherein the calculating comprises calculating the speed increment information so that the relative eccentricity vector and the relative gradient vector are in a parallel state.

6. The method of claim 3, wherein the calculating comprises calculating the speed increment information so that the relative eccentricity vector and the relative gradient vector are in a state aside from a vertical state.

7. The method of claim 1, wherein the calculating comprises calculating the speed increment information so that a changed distance between the current satellite and the other satellite is greater than or equal to the measured distance.

8. The method of claim 3, wherein the calculating comprises determining a maneuver time based on a bias value of the relative eccentricity vector.

9. The method of claim 3, wherein the calculating comprises determining the speed increment information or a maneuver time based on a bias value of the relative gradient vector.

10. The method of claim 1, wherein the measuring comprises modulating or demodulating a signal of the radio frequency.

11. The method of claim 1, wherein the calculating comprises determining a maneuver time based on a change in an eccentricity.

12. A satellite orbit adjusting apparatus comprising:
a relative location calculator configured to measure a distance between a current satellite and another satellite using a radio frequency, and to calculate a relative location relationship between the current satellite and the other satellite based on the measured distance; and
a speed increment calculator configured to estimate an orbit element based on the location relationship, and to calculate speed increment information for controlling a maneuver based on the estimated orbit element, wherein a satellite orbit of the current satellite is adjusted based on the speed increment information.

13. The satellite orbit adjusting apparatus of claim 12, wherein the speed increment calculator is configured to calculate a value of a relative eccentricity vector and a value of a relative gradient vector based on the estimated orbit element.

14. The satellite orbit adjusting apparatus of claim 12, wherein the speed increment calculator is configured to determine a maneuver time based on a change in an eccentricity.

15. A satellite orbit adjusting apparatus comprising:
a relative location calculator configured to measure a distance between a current satellite and another satellite using a radio frequency; and
a speed increment calculator configured to estimate an orbit element of the current satellite based on the measured distance, to control a maneuver of the current satellite based on the estimated orbit element, and to adjust the satellite orbit of the current satellite.
